(19) United States
(12) Patent Application Publication
(10) Pub. No.: US 2015/0189565 A1
(43) Pub. Date: Jul. 2, 2015

(54) METHOD AND APPARATUS FOR BASE STATION ASSOCIATION FOR AVOIDING FREQUENT HANDOVER IN FEMTOCELL NETWORK

(71) Applicant: Electronics and Telecommunications Research Institute, Daejeon (KR)

(72) Inventors: Nak Woon SUNG, Daejeon (KR); Yong Seouk CHOI, Daejeon (KR)

(73) Assignee: Electronics and Telecommunications Research Institute, Daejeon (KR)

(21) Appl. No.: 14/224,694

(22) Filed: Mar. 25, 2014

(30) Foreign Application Priority Data
Dec. 31, 2013 (KR) 10-2013-0169070

(51) Int. Cl. H04W 36/16; H04W 48/16

(52) U.S. Cl. CPC H04W 36/165; H04W 48/16

(57) ABSTRACT

In a network including a macrocell and a femtocell, a terminal measures a current mobility state indicating a base station that is currently associated with the terminal and a future mobility state indicating a base station that is to be associated with the terminal in the future, and calculates expectation rewards for the base stations in consideration of information on neighbor base stations provided from a serving base station. In addition, the terminal selects a base station providing the largest expectation reward.

### CROSS-REFERENCE TO RELATED APPLICATION

This application claims priority to and the benefit of Korean Patent Application No. 10-2013-0169070 filed in the Korean Intellectual Property Office on Dec. 31, 2013, the entire contents of which are incorporated herein by reference.

### BACKGROUND OF THE INVENTION

(a) Field of the Invention

The present invention relates to a handover. More particularly, the present invention relates to a method and an apparatus for base station association for avoiding frequent handover in a femtocell network.

(b) Description of the Related Art

Generally, a femtocell is a communication area based on a small base station sending a signal with small power in an indoor space. In the femtocell, due to a short distance to a base station (BS), coverage and capacity are improved and interference is decreased, such that quality of service (QoS) of a user is increased. In terms of service providers, there is an advantage that more resources may be provided to femtocell users as compared with macrocell users at a small investment cost.

However, a small cell size of the femtocell may cause frequent handovers. However, these frequent handovers increase a medium access control (MAC) signaling overhead, thereby decreasing QoS of the user.

In a macrocell handover according to the related art, the number of handovers has decreased using a method such as a hysteresis margin, windowing, a handover delay timer, or the like. In this method, the handover is generated only when the state in which a signal of a macro base station is larger than a signal of a serving base station (SBS) by a hysteresis margin is continued during a handover delay time. This method may decrease the number of handovers, but has a problem that throughput is decreased due to a delay of the handover.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for base station association having advantages of selecting an optimal base station capable of decreasing the number of handovers as much as possible in a two-layer network including a macro base station and a femtocell base station.

An exemplary embodiment of the present invention provides a method for base station association in which a terminal is associated with a base station in a network including a macrocell and a femtocell, including: measuring, by the terminal, a current mobility state indicating a base station that is currently associated with the terminal and a future mobility state indicating a base station that is to be associated with the terminal in the future; receiving, by the terminal, a list including information on neighbor base stations from a serving base station; calculating, by the terminal, each of expectation rewards for the neighbor base stations included in the list based on the current mobility state, the future mobility state, and the information on the neighbor base stations; and selecting, by the terminal, a base station providing the largest expectation reward.

In the measuring of the current mobility state and the future mobility state, the current mobility state and the future mobility state may be measured based on a predetermined mobility model. The mobility model may be a Markov mobility model.

The information included in the list may include a diversity gain and a data rate of each base station.

In the calculating of each of the expectation rewards, each of the expectation rewards may be calculated based on the diversity gain, the current mobility state, and the future mobility state.

The list may be created by the serving base station based on moving average values, which are diversity gains broadcasted from base stations. Each base station may monitor the number of terminals associated therewith, estimate diversity gain information, calculate the moving average values based on the estimated diversity gain information, and broadcast the calculated moving average values.

The expectation reward may indicate a total sum of effective throughputs that is obtainable from a corresponding base station from a current point in time to a future point t₀ in time except for a handover cost.

The method for base station association may further include performing, by the terminal, a handover to the selected base station in the case in which the selected base station is different from a current serving base station. The method for base station association may further include, after the receiving of the list, measuring, by the terminal, received signal strengths (RSSs) for the base stations included in the list and feeding back and reporting, by the terminal, the measured RSSs to the serving base station.

The method for base station association may further include reporting, by the terminal, the measured current mobility state and the measured future mobility state to the serving base station.

Another embodiment of the present invention provides an apparatus for base station association in which a terminal is associated with a base station in a network including a macrocell and a femtocell, including: a mobility state measuring unit measuring a current mobility state indicating a base station that is currently associated with the terminal and a future mobility state indicating a base station that is to be associated with the terminal in the future; an RSS measuring unit receiving a list including information on neighbor base stations from a serving base station; an expectation reward calculating unit calculating each of expectation rewards for the neighbor base stations included in the list based on the current mobility state, the future mobility state, and the information on the neighbor base stations; and a base station selecting unit selecting a base station providing the largest expectation reward based on the calculated expectation rewards.

The information included in the list may include a diversity gain and a data rate of each base station, and the expectation reward calculating unit may calculate each of the expectation rewards based on the diversity gain, the current mobility state, and the future mobility state.

The expectation reward calculating unit may calculate the expectation reward indicating a total sum of effective throughputs that is obtainable from a corresponding base station from a current point in time to a future point t₀ in time except for a handover cost.

The RSS measuring unit may measure RSSs for the base stations included in the list and feed back and report the measured RSSs to the serving base station.

According to an exemplary embodiment of the present invention, in a two-layer network including a macro base station and a femtocell base station, the number of handovers may be minimized based on a dynamic programming method. Particularly, a base station capable of maximizing an expectation reward in a future time point (e.g., a t₀ slot) as well as a current expectation reward is selected, thereby making it possible to decrease frequent handovers in a total time horizon.

A distributed handover framework capable of decreasing frequent handovers may be provided.

### BRIEF DESCRIPTION OF THE DRAWINGS

FIG. 1 is a diagram showing a network environment in which a handover is performed according to an exemplary embodiment of the present invention.

FIG. 2 is an illustrative diagram showing a terminal mobility prediction path according to an exemplary embodiment of the present invention.

FIG. 3 is a diagram showing operation timing according to an exemplary embodiment of the present invention.

FIG. 4 is a flowchart of a method for base station association according to an exemplary embodiment of the present invention.

FIG. 5 is a diagram showing a structure of an apparatus for base station association according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In the specification and the claims, unless explicitly described to the contrary, the word “comprise” and variations such as “comprises” or “comprising” will be understood to imply the inclusion of stated elements but not the exclusion of any other elements.

In the specification, a terminal may represent a mobile terminal (MT), a mobile station (MS), an advanced mobile station (AMS), a high reliability mobile station (HR-MS), a subscriber station (SS), a portable subscriber station (PSS), an access terminal (AT), user equipment (UE), or the like, and may include all or some of the functions of the MT, the MS, the AMS, the HR-MS, the SS, the PSS, the AT, the UE, or the like.

In addition, a base station (BS) may represent an advanced base station (ABS), a high reliability base station (HR-BS), a node B, an evolved node B (eNodeB), an access point (AP), a radio access station (RAS), a base transceiver station (BTS), a mobile multi-hop relay (MMR)-BS, a relay station (RS) serving as a base station, a relay node (RN) serving as a base station, an advanced relay station (ARS) serving as a base station, a high reliability relay station (HR-RS) serving as a base station, a small base station [(femto BS), a home node B (HNB), a pico BS, a metro BS, a micro BS, or the like], or the like, and may include all or some of the functions of the ABS, the nodeB, the eNodeB, the AP, the RAS, the BTS, the MMR-BS, the RS, the RN, the ARS, the HR-RS, the small base station, or the like.

Hereinafter, a method and an apparatus for base station association according to an exemplary embodiment of the present invention will be described.

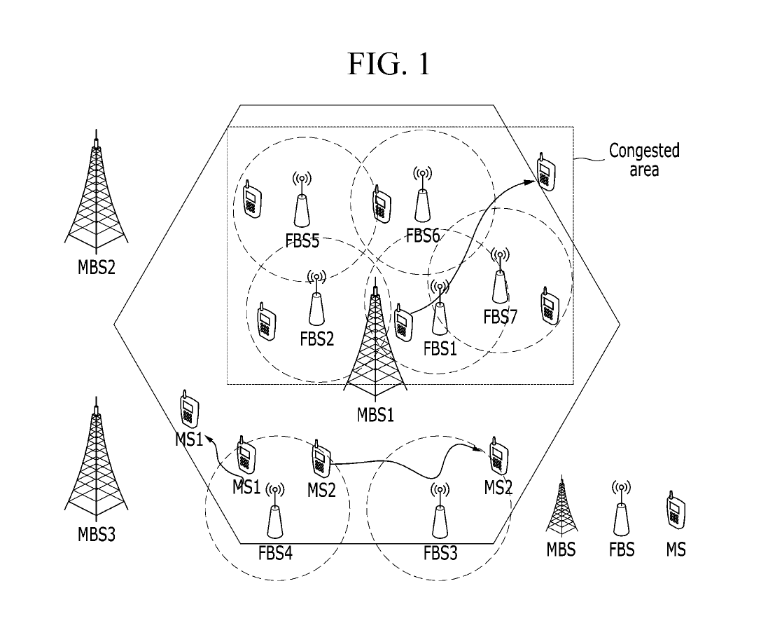

FIG. 1 is a diagram showing a network environment in which a handover is performed according to an exemplary embodiment of the present invention.

As shown in FIG. 1, in a network environment in which a plurality of small cells coexist, that is, in a two-layer network in which a macrocell base station (MBS) 1 and a femtocell base station (FBS) (that may also be referred to as a femtocell access point (FAP)) 2 coexist, a mobile station (MS) 3 access a corresponding cell through a base station managing each cell.

In order to provide a good communication service even in an indoor space, a femtocell base station, which is a cost-effective indoor coverage technology, is used, and a coverage area of the femtocell base station is, for example, about 20 to 50 m. These femtocell base stations may be arbitrarily installed.

A plurality of femtocell base stations may be installed in a single macrocell area. For example, as shown in FIG. 1, in a congested area, the macro base station MBS1 may provide a communication service, and a plurality of femtocell base stations FBS1 to FBS7 may also be installed to provide communication services.

In this environment, various types of handovers are possible. In addition to a handover between macrocells, a handover from a macrocell to a femtocell (also referred to as a hand-in), a handover between femtocells (also referred to as an inter-FAP), a handover from a femtocell to a macrocell (also referred to as a handout), and the like, are possible.

In the state in which these handovers are possible, a macrocell base station according to the related art allows a handover to a neighbor base station (NBS) with strong received signal strength indication (RSSI) of a predetermined value or more to be performed. However, due to a small cell size of the femtocell base station, frequent handovers may be caused. These frequency handovers increase a MAC signaling overhead, thereby decreasing QoS of a user.

In an exemplary embodiment of the present invention, a method for base station association is suggested in order to decrease unnecessary handovers in this network environment.

In an exemplary embodiment of the present invention, it is assumed that mobility of each terminal is decided by a predetermined mobility prediction model. Although a Markov mobility model has been used as the mobility prediction model herein, the present invention is not necessarily limited thereto.

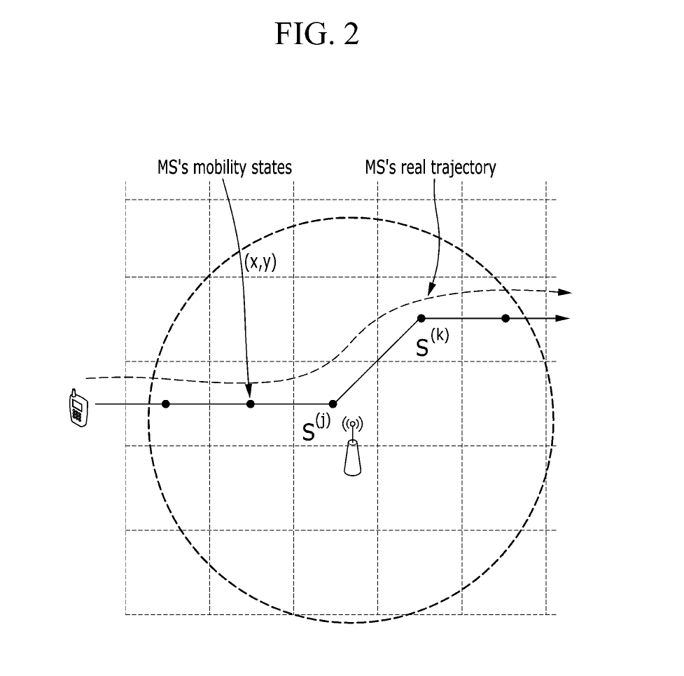

FIG. 2 is an illustrative diagram showing a terminal mobility prediction path according to an exemplary embodiment of the present invention.

In a Markov mobility model according to an exemplary embodiment of the present invention, an entire cell may be divided into a plurality of square s^{(j)} areas as shown in FIG. 2, a terminal MSi is located in one sᵢ^{(t)} of the plurality of square s^{(j)} areas at time t. In addition, it is assumed that a probability that the terminal MSi will be present in an area j at the point t in time and will move to an area k at time t+1 is given by pᵢ^{(j,k)}=Pr[sᵢ(t+1)=s^{(k)}|sᵢ(t)=s^{(j)}]. The probability may be called a one-step transition probability. Although a Markov process depending on the Markov mobility model has been used for convenience of formulation herein, the present invention is not limited thereto. For example, a method such as learning method, a random number generating method, or the like, or a location prediction method using a Kalman filter, or the like, may be used instead of the Markov process.

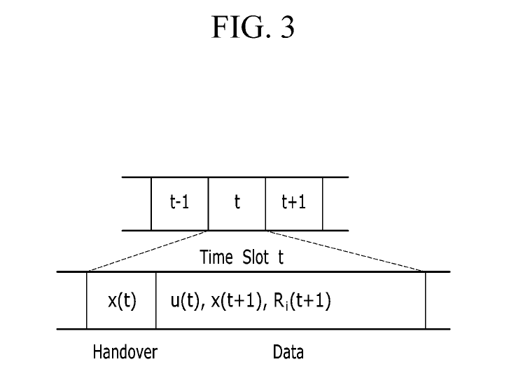

In a network environment in which N base stations and I terminals are present, signals are transmitted and received in a time slot unit as shown in FIG. 3.

FIG. 3 is a diagram showing operation timing according to an exemplary embodiment of the present invention.

As shown in FIG. 3, an operation is performed in a time slot unit, that is, t={0, 1, 2, . . . } unit, such that each time slot is configured of a handover sub-slot and a data sub-slot. Each terminal selects an optimal associated base station in the handover sub-slot and receives a service in association with the selected base station during the data sub-slot.

It may be represented by x(t)={x_{i,n}}_{iεI,nεN} using a state variable for a base station each terminal is associated with at time t. Here, x(t) indicates a state variable.

When the terminal MSi is associated with a base station BSn, a state variable element x_{j,n} of the terminal MSi becomes 1. In addition, the terminal MSi is associated with only one base station at each time slot. Therefore, a condition of Σ_{nεN} X_{i,n}=1 is satisfied.

A throughput Rᵢ(t) of each terminal MSi may be modeled as follows.

$${R}_{i} ( t ) = \frac{h ( {y}_{n} ( t ) )}{{y}_{n} ( t )} {r}_{i} ( t ) \qquad ( Equation 1 )$$

Here, ri(t) indicates a data rate of the terminal MSi in an area s(j), and h(y) indicates a multi-user diversity gain. The data rate rᵢ(t) of each terminal and the multi-user diversity gain h(y) are represented in detail as follows.

$${r}_{i} ( t ) = {W}_{n} log ( 1 + \frac{g ( n , {s}_{i} ( t ) ) {P}_{0}}{η ( n , {s}_{i} ( t ) )} ) \\ h ( y ) = {\sum }_{z = 1}^{y} \frac{1}{z} \qquad ( Equation 2 )$$

Here, y indicates the number of terminals associated with a base station BSn, and yₙ(t)=Σ_{iεI} X_{i,n}(t). g(n, sᵢ(t)) indicates a channel gain obtained using a path-loss model, and P₀ indicates transmission power of the base station BSn. g(n,sᵢ(t)) n,sᵢ(t) indicates a mobility state, that is, an additive noise value in sᵢ(t).

In an exemplary embodiment of the present invention, minimization of a handover is modeled by throughput loss due to the handover.

When the terminal MSi decides handover at the handover sub-slot, a difference between a state variable x(t) in t and a state variable x(t+1) in t+1 is larger than 0. Therefore, in an exemplary embodiment of the present invention, effective throughput of the terminal MSi during the data sub-slot is defined as effective throughput (Rᵢ(t+1)) in the case in which a handover to a new base station has been performed. Rᵢ(t+1) is throughput except for a signaling overhead cost at the time of performing the handover to a new base station. In an exemplary embodiment of the present invention, base stations capable of maximizing effective throughputs of all terminals over a total time, that is, T time slots are selected, which is represented by the following Equation 3.

$$max {\sum }_{t = 0}^{T} {\sum }_{i ∈ I}^{ } ( 1 - \frac{ɛ}{2} {( {x}_{i} ( t + 1 ) - {x}_{i} ( t ) )}^{2} ) {R}_{i} ( t + 1 ) \qquad ( Equation 3 )$$

ε: handover disruption cost due to handover

In an example embodiment of the present invention, in order to maximize the total effective throughput of all terminals over T time slots according to Equation 3, a handover control problem may be considered as a sequential decision problem with T stages and is formulated using a dynamic programming method. The handover control problem is to find an optimal control policy that maximizes the total effective throughput of all terminals over T time slots.

Based on a dynamic programming method according to an exemplary embodiment of the present invention, a state variable means a state x(t) of the terminal associated with the base station at time t. A mobility path, which is a random variable, is decided depending on a mobility model in the handover sub-slot at time t, and a base station providing an optimal reward, that is, u(t) is selected, such that a transition to a state x(t+1) is made. A network-wide total reward that may be obtained by an entire system at time t may be represented by the following Equation 4.

$$c ( x ( t ) , u ( t ) ) = {\sum }_{i ∈ I}^{ } {\sum }_{{s}^{( j )} ∈ S}^{ } {p}_{i}^{( j )} ( t ) {c}_{i}^{( j )} ( x ( t ) , u ( t ) ) \\ Here , \\ {c}_{i}^{( j )} ( x ( t ) , u ( t ) ) = ( 1 - \frac{ɛ}{2} {( {x}_{i} ( t ) - {u}_{i} ( t ) )}^{2} ) {R}_{i}^{( j )} ( x ( t ) , u ( t ) ) , \\ {R}_{i}^{( j )} ( x ( t ) , u ( t ) ) = {\sum }_{n ∈ {N}_{i} ( t )}^{ } {R}_{i , n}^{( j )} ( x ( t ) , u ( t ) ) {x}_{i , n} ( t + 1 ) , \\ {R}_{i , n}^{( j )} ( x ( t ) , u ( t ) ) = h ( {\sum }_{i ∈ I}^{ } {x}_{i , n} ( t + 1 ) ) {W}_{0} log ( 1 + \frac{g ( n , {s}^{( j )} ) {P}_{0}}{η ( n , {s}^{( j )} )} ) \qquad ( Equation 4 )$$

A reward R_{i,n}^{(j)}(x(t),u(t)) depending on the above Equation 2 indicates a total sum of effective throughputs that may be obtained from the base station except for a handover cost when each terminal MSi makes a decision for association with a new base station in each area s(j) and selects the base station u(t) providing an optimal reward.

In the dynamic programming method based system, a terminal objective function may be represented by the following Equation 5.

$${max}_{π} {J}^{( π )} ( x ( 0 ) ) = \{ c ( x ( T ) , u ( T ) ) + {\sum }_{t = 0}^{T - 1} c ( x ( t ) , u ( t ) ) \} \\ π = {\{ u ( t ) \}}_{t = 0 , 1 , … , T - 1} \qquad ( Equation 5 )$$

The terminal objective function depending on the above Equation 5 indicates that a total reward from an initial state t₀ stage to a terminal state T stage is maximized. Therefore, the handover control problem may be defined as an optimal handover control action satisfying the above Equation 5, that is, a problem of selecting t. However, there is a problem that mobility of the terminal is a random variable and complexity of the terminal objective function is rapidly increased in accordance with an increase in the number of terminals/base stations and a time T.

As in the above Equation 5, an optimal solution of the objective function of the dynamic programming method may be defined by a backward induction method. In the backward induction method, optimal handover for each stage is decided in a reverse sequence from the terminal state T stage to the t₀ stage. However, since a terminal state x*(T) and complete mobility information of the terminal are required, complexity of a solution is rapidly increased in accordance with an increase in a time T value.

Therefore, in an exemplary embodiment of the present invention, the terminal objective function as represented by the above Equation 5 is approximated to a problem during a shorter time horizon T₀ period. That is, a problem of the above Equation 5 is approximated to approximate dynamic programming and is also distributed and processed as a problem of each terminal, such that an optimal associated base station is selected in real time.

For this purpose, in stage 1, an optimal solution of an objective function of the above Equation 3 during a short time horizon T₀ rather than a total time horizon T (T₀<T) is found. This method is known as a lookahead policy in a dynamic programming method, and has an advantage that future location prediction information may be utilized. Therefore, in an exemplary embodiment of the present invention, future mobility of the terminal is predicted using the future location prediction information, thereby making it possible to minimize unnecessary handovers.

A solution of the objective function of the above Equation 5 defined as the terminal objective function during the total time horizon may be approximated as represented by the following Equation 6.

$${J}_{t , t + {T}_{0}}^{( L )} ( x ( t ) ) = {max}_{u ( τ ) , ∀ τ = [ t , t + {T}_{0} ]} \{ {\sum }_{τ = t}^{τ = t + {T}_{0}} c ( x ( τ ) , u ( τ ) ) \} \qquad ( Equation 6 )$$

The above Equation 6 is used to approximate the objective function depending on the above Equation 5 by a T₀-lookahead policy of approximating the objective function to a problem during a short time horizon T₀. This T₀-lookahead policy may allow each terminal to perform a handover in consideration of a reward in a future mobility location given by the Markov mobility model or the Kalman filter as well as a reward at time t.

In addition, in the T₀-lookahead policy, the larger the T₀ value, the closer an optimal solution to the throughput is. However, since approximation of the objective function depending on the above Equation 6 is processed by a central node, there is an overhead of which all nodes should transmit feedback information to the central node. For example, all terminals should report their current data rates to the central node, and base stations should report diversity gain information. In addition, even though the central node has all this information, there is a problem that computation overhead based on the information is large.

Therefore, in an exemplary embodiment of the present invention, in stage 2, a distributed online algorithm through which each of a plurality of terminals (e.g., I terminals) may perform handover depending on a reward function rather than a handover by the central node is defined. For this purpose, a total reward function depending on the above Equation 4 is decomposed into reward functions for I terminals. When the total reward function suggested in the above Equation 4 is decomposed into reward functions for the respective terminals, it may be represented by the following Equation 7.

$${c}_{i}^{( J )} ( x ( t ) , u ( t ) ) = {\sum }_{{s}^{( j )} ∈ S}^{ } {p}_{i}^{( j )} ( 1 - \frac{ɛ}{2} {( {x}_{i} ( t ) - {u}_{i} ( t ) )}^{2} ) {R}_{i}^{( j )} ( x ( t ) , u ( t ) ) \\ Here , \\ {R}_{i}^{( j )} ( x ( t ) , u ( t ) ) = {\sum }_{n ∈ {N}_{i} ( t )}^{ } {R}_{i , n}^{( j )} ( x ( t ) , u ( t ) ) {x}_{i , n} ( t ) , \\ {R}_{i , n}^{( j )} ( x ( t ) , u ( t ) ) = {h}_{n} {W}_{n} log ( 1 + \frac{g ( n , {s}^{( j )} ) {P}_{0}}{η ( n , {s}^{( j )} )} ) \qquad ( Equation 7 )$$

A reward function depending on the above Equation 7 is decided based on a current association state of the terminal, new handover decision, and a multi-user diversity gain of each neighbor base station. While the current association state and the handover decision are independent variables of each terminal, the multi-user diversity gain of each neighbor base station is a real-time variable correlated to other terminals. Therefore, in an exemplary embodiment of the present invention, the multi-user diversity gain value, that is,

$$h ( y ) = {\sum }_{z = 1}^{y} \frac{1}{z} ,$$

is replaced by a moving average value hₙ. For this purpose, each base station periodically monitors the number of terminals associated therewith and estimates instant diversity gain information. In addition, each base station calculates the moving average value based on the estimated diversity gain information and broadcasts the calculated moving average value to the neighbor base stations. A serving base station creates a neighbor list including the moving average values broadcasted from the base stations and transmits the created neighbor list to the terminals.

Therefore, in the above Equation 7, a terminal reward function of each terminal is decided by only selection of base station association by each terminal, and an objective function of the above Equation 6, which is a centralized algorithm processed by the central node, may be defined as a handover algorithm distributed for each terminal as represented by the following Equation 8.

$${J}_{t , t + {T}_{0}}^{( L , i )} ( {x}_{i} ( t ) ) = {max}_{{u}_{i} ( τ ) , ∀ τ = [ t , t + {T}_{0} ]} {\sum }_{τ = t}^{τ = t + {T}_{0}} ( \begin{matrix}c ( {x}_{i} ( τ ) , {u}_{i} ( τ ) ) + \\ {\sum }_{n ∈ {N}_{i}}^{ } \frac{{h}_{n} ( t )}{{y}_{n} ( t ) + {u}_{i , n} ( τ )} {r}_{n} ( t )\end{matrix} ) ) \qquad ( Equation 8 )$$

According to an exemplary embodiment of the present invention, each terminal selects a base station maximizing an expectation reward in a slot in a future point T₀ in time as well as a current expectation reward at the time of deciding a handover. Further, each terminal performs a handover so as to maximize an expectation reward of each neighbor base station as well as an expectation reward of each terminal obtained depending on the handover decision.

A method for base station association for the handover based on the dynamic programming method as described above may be performed as follows.

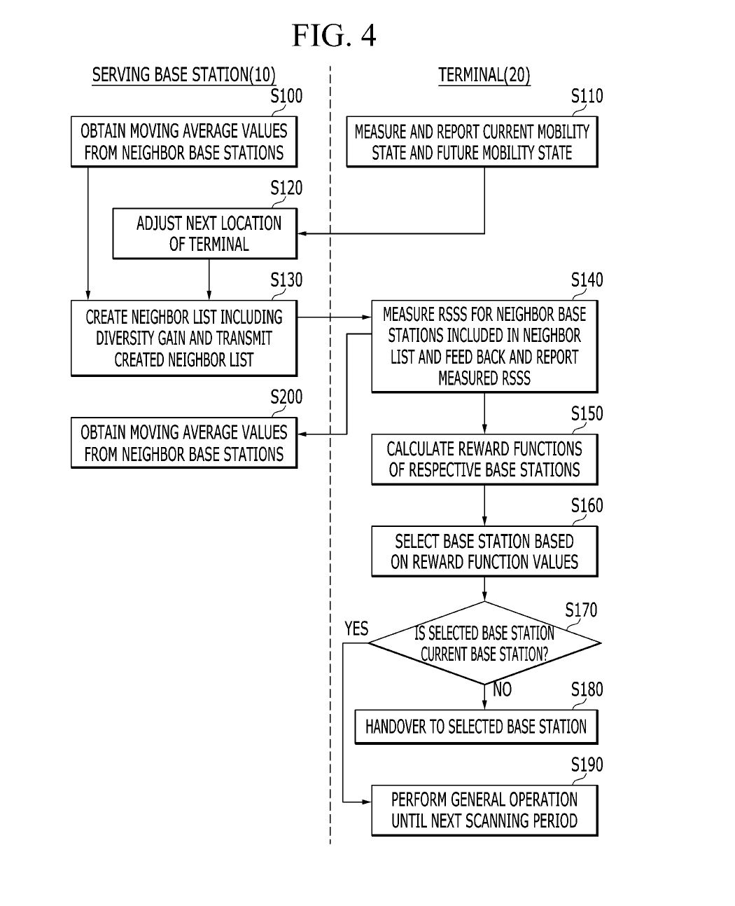

FIG. 4 is a flowchart of a method for base station association according to an exemplary embodiment of the present invention.

In the network environment as shown in FIG. 1, each base station monitors the number of terminals associated therewith and estimates diversity gain information based on the monitored number of terminals associated therewith. In addition, each base station calculates a moving average value based on the estimated diversity gain information and broadcasts the calculated moving average value to neighbor base stations. A serving base station 10 receives information, that is, the moving average values (diversity gains), broadcasted from the neighbor base stations (S100).

A terminal 20 measures a current mobility state and a future mobility state depending on a predetermined mobility model. The terminal reports the current mobility state indicating a base station that is currently associated therewith and the future mobility state indicating a base station that is to be associated therewith in the future to the serving base station 10 (S110).

The serving base station 10 receives the current mobility state and the future mobility state reported from the terminal and adjusts the next location of the terminal based on the current mobility state and the future mobility state (S120). Then, the serving base station 10 creates a neighbor list based on the information, that is, the moving average values, received from the neighbor base stations and transmits the created neighbor list to the terminal 20 (S130). Here, the neighbor list may include diversity gain and rate information for each neighbor base station.

The terminal 20 measures received signal strengths (RSSs) for the respective neighbor base stations based on the neighbor list transmitted from the serving base station, and feeds back and reports the measured RSSs to the serving base station 10 (S140).

The terminal 20 selects a base station ensuring optimal throughput based on the information included in the neighbor list received from the serving base station, and the current mobility state and the future mobility state measured depending on the mobility model. That is, the terminal calculates reward functions of the respective base stations based on a current mobility state, which is a current association state of the terminal, a future mobility state depending on a new handover decision, and multi-user diversity gains of the respective neighbor base stations, according to the above Equation 7 (S150). Then, the terminal selects a base station ensuring optimal throughput based on the above Equation 8, based on the calculated reward function values of the respective base stations (S160).

Then, the terminal 20 performs a handover in the case in which the selected base station is different from a current base station (S170 and S180). Although a mobility model has been assumed in an example of the handover of the present invention described above, a prediction method such as a Kalman filter may be applied in order to predict future mobility of the terminal.

Meanwhile, in S140, the serving base station 10 receiving the RSSs fed back and reported from the terminal updates the RSSs for the neighbor base stations based on the RSSs of the respective base stations, calculates moving average diversity gains based on the updated RSSs, and transmits the calculated moving average diversity gains to the neighbor base stations (S190).

According to an exemplary embodiment as described above, in the two-layer network environment, movement of the terminal is decided by the mobility model, the effective throughput that may be obtained by the system during the total time horizon is formulated using the dynamic programming method and approximated, and the respective terminals select an associated base station depending on the distributed algorithm so as to contribute to maximizing of the throughput of the entire system. Therefore, minimization of the handover may be realized by minimizing throughput loss due to the handover. Therefore, unnecessary handovers between the femtocell base stations may be minimized, and a terminal moving at a predetermined speed or more is allowed to be associated with the macro base station, thereby making it possible to decrease unnecessary handovers due to association between the terminal and the femtocell base station.

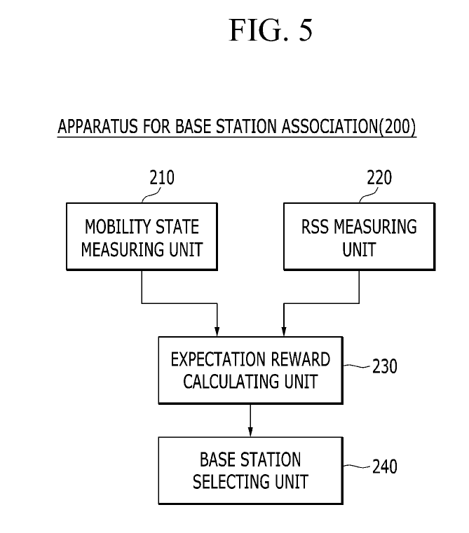

FIG. 5 is a diagram showing a structure of an apparatus for base station association according to an exemplary embodiment of the present invention.

As shown in FIG. 5, an apparatus 200 for base station association according to an exemplary embodiment of the present invention is configured to include a mobility state measuring unit 210, an RSS measuring unit 220, an expectation reward calculating unit 230, and a base station selecting unit 240.

The mobility state measuring unit 210 measures a current mobility state and a future mobility state depending on a predetermined mobility model, and reports the measured mobility states to the serving base station.

The RSS measuring unit 220 receives a neighbor list including diversity gain and rate information of the respective neighbor base stations from the serving base station, and measures RSSs for the neighbor base stations included in the received neighbor list. In addition, the RSS measuring unit feeds back and reports information on the RSSs measured for the neighbor base stations to the serving base station.

The expectation reward calculating unit 230 calculates expectation rewards based on a current association state of the terminal, new handover decision, and multi-user diversity gains of the respective neighbor base stations. That is, the expectation reward calculating unit 230 calculates reward functions of the respective base stations based on a current mobility state, which is a current association state of the terminal, a future mobility state depending on new handover decision, and multi-user diversity gains of the respective neighbor base stations.

The base station selecting unit 240 selects a base station that is to be newly accessed based on values of the reward functions of the respective base stations. The base station selecting unit 240 selects a base station of which a value of the reward function is the largest as the base station that is to be newly accessed. In the case in which the base station selected by the base station selecting unit 240 is different from a current base station, a handover may be performed.

The above-mentioned exemplary embodiments of the present invention are not embodied only by an apparatus and method. Alternatively, the above-mentioned exemplary embodiments may be embodied by a program performing functions which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for base station association in which a terminal is associated with a base station in a network including a macrocell and a femtocell, comprising:
measuring, by the terminal, a current mobility state indicating a base station that is currently associated with the terminal and a future mobility state indicating a base station that is to be associated with the terminal in the future;
receiving, by the terminal, a list including information on neighbor base stations from a serving base station;
calculating, by the terminal, each of expectation rewards for the neighbor base stations included in the list based on the current mobility state, the future mobility state, and the information on the neighbor base stations; and
selecting, by the terminal, a base station providing the largest expectation reward.

2. The method of claim 1, wherein
in the measuring of the current mobility state and the future mobility state, the current mobility state and the future mobility state are measured based on a predetermined mobility model.

3. The method of claim 2, wherein
the mobility model is a Markov mobility model.

4. The method of claim 1, wherein
the information included in the list includes a diversity gain and a data rate of each base station.

5. The method of claim 1, wherein,
in the calculating of each of the expectation rewards,
each of the expectation rewards is calculated based on the diversity gain, the current mobility state, and the future mobility state.

6. The method of claim 2, wherein
the list is created by the serving base station based on moving average values, which are diversity gains broadcasted from base stations.

7. The method of claim 6, wherein
each base station monitors the number of terminals associated therewith, estimates diversity gain information, calculates the moving average values based on the estimated diversity gain information, and broadcasts the calculated moving average values.

8. The method of claim 1, wherein
the expectation reward indicates a total sum of effective throughputs that is obtainable from a corresponding base station from a current point in time to a future point T₀ in time except for a handover cost.

9. The method of claim 1, further comprising
performing, by the terminal, a handover to the selected base station in the case in which the selected base station is different from a current serving base station.

10. The method of claim 1, further comprising,
after the receiving of the list,
measuring, by the terminal, received signal strengths (RSSs) for the base stations included in the list and feeding back and reporting, by the terminal, the measured RSSs to the serving base station.

11. The method of claim 1, further comprising:
reporting, by the terminal, the measured current mobility state and the measured future mobility state to the serving base station.

12. An apparatus for base station association in which a terminal is associated with a base station in a network including a macrocell and a femtocell, comprising:
a mobility state measuring unit measuring a current mobility state indicating a base station that is currently associated with the terminal and a future mobility state indicating a base station that is to be associated with the terminal in the future;
an RSS measuring unit receiving a list including information on neighbor base stations from a serving base station;
an expectation reward calculating unit calculating each of expectation rewards for the neighbor base stations included in the list based on the current mobility state, the future mobility state, and the information on the neighbor base stations; and
a base station selecting unit selecting a base station providing the largest expectation reward based on the calculated expectation rewards.

13. The apparatus of claim 12, wherein:
the information included in the list includes a diversity gain and a data rate of each base station; and
the expectation reward calculating unit calculates each of the expectation rewards based on the diversity gain, the current mobility state, and the future mobility state.

14. The apparatus of claim 12, wherein
the expectation reward calculating unit calculates the expectation reward indicating a total sum of effective throughputs that is obtainable from a corresponding base station from a current point in time to a future point t₀ in time except for a handover cost.

15. The apparatus of claim 12, wherein
the RSS measuring unit measures RSSs for the base stations included in the list and feeds back and reports the measured RSSs to the serving base station.
